(19) United States
(12) Patent Application Publication
(10) Pub. No.: US 2010/0206537 A1
(43) Pub. Date: Aug. 19, 2010

(54) HEAT SPREADER FOR SEMICONDUCTOR DEVICE AND METHOD FOR MANUFACTURING THE SAME

(76) Inventors: Toshiya Ikeda, Toyama (JP); Shigeki Koyama, Toyama (JP); Shinya Nishida, Toyama (JP)

Correspondence Address: MCDERMOTT WILL & EMERY LLP, 600 13TH STREET, N.W., WASHINGTON, DC, 20005-3096, US

(21) Appl. No.: 12/599,635

(22) PCT Filed: May 20, 2008
(86) PCT No.: PCT/JP2008/059170

§ 371 Date: Nov. 10, 2009

(30) Foreign Application Priority Data
May 29, 2007 (JP) 2007-142561

(51) Int. Cl. F28F 7/00; B23P 15/26

(52) U.S. Cl. 165/185; 29/890.054

(57) ABSTRACT

Provided are a heat spreader for a semiconductor device, which can be joined such that a multitude of pin-shaped fins are not easily fractured even when the heat spreader for a semiconductor device is incorporated in a heat dissipation structure for a semiconductor device, in which direct cooling is performed by using water, and a method for manufacturing the heat spreader for a semiconductor device. The heat spreader (1) for a semiconductor device comprises: a plurality of columnar members (13) joined onto at least one of surfaces of a plate-like member (11, 12) by stud welding; and a joining layer (14) formed between the plate-like member (11, 12) and the columnar members (13). The plate-like member (11, 12) includes a base material (11) and surface layers (12). The surface layers (12) and the columnar members (13) are made of a material containing aluminum or an aluminum alloy. A thickness of the plate-like member (11, 12) is 0.5 mm through 6 mm and a thickness of each of the surface layers (12) is 0.1 mm through 1 mm. The joining layer (14) has a joining interface (15) on a boundary with the plate-like member (11, 12). A proportion of an area of the joining interface (15) being present in the surface layer (12) is greater than or equal to 50% and less than or equal to 100%, converted in terms of a plane projected to the one of the surfaces of the plate-like member.

### TECHNICAL FIELD

The present invention relates generally to a heat spreader for a semiconductor device and a method for manufacturing the heat spreader for a semiconductor device, and, more particularly, to a heat spreader for a power device such as an insulated gate bipolar transistor (IGBT) which is mounted in an automobile or the like, and to a method for manufacturing the head spreader.

### BACKGROUND ART

In a power device, such as an IGBT, used for controlling a motor in an electric train, an electric automobile, or the like, a heat spreader is used in order to effectively dissipate heat generated by a semiconductor device.

FIG. 6 is a schematic diagram illustrating a heat dissipation structure for a semiconductor device, in which a conventional heat spreader is used.

As shown in FIG. 6, aluminum layers 3 (or copper layers) are formed on both side surfaces of an insulating substrate 4 made of aluminum nitride, silicon nitride, alumina, or the like. On one surface of the sides of the insulating substrate 4, on which the aluminum layer 3 is formed, a semiconductor device 5 is mounted with a soldering layer 2 interposed therebetween. On the other surface of the sides of the insulating substrate 4, on which the aluminum layer 3 is formed, a heat spreader made of a copper-molybdenum alloy plate 6 is joined with a soldering layer 2 interposed therebetween. In order to ensure joining performance of the soldering layers, surfaces of the copper-molybdenum alloy plate 6 are nickel-plated. On the other surface of the copper-molybdenum alloy plate 6, which is opposite to the one surface thereof joined to the insulating substrate 4, a cooling unit 500 is attached with a heat-conductive grease 7 interposed therebetween. Inside the cooling unit 500, a coolant circulation channel 530 for circulating water or other liquid as a coolant by a pump 510 is formed. The cooling unit 500 includes a radiator 520, thereby eventually releasing heat into the atmosphere. The heat spreader made of the copper-molybdenum alloy plate 6 serves to conduct local heat generated by the semiconductor device 5 to the coolant circulation channel 530 in the cooling unit 500.

In order to achieve the above-mentioned object, a high heat conductivity is required of the heat spreader. In addition, in order to prevent a thermal stress fracture caused by a change in a temperature of the mounted semiconductor device, thermal expansion properties close to those of a material of the insulating substrate are required of the heat spreader.

As a material of the heat spreader, which satisfies these requirements, a copper-molybdenum alloy plate has conventionally been used.

However, the copper-molybdenum alloy plate has some drawbacks.

A first problem is that a weight thereof is heavy. In particular, in a transport machine of which a reduction in a weight is required, this problem poses a great challenge.

A second problem is that it is suggested that a cooling efficiency cannot be increased because the heat-conductive grease 7 is interposed between the copper-molybdenum alloy plate 6 and the cooling unit 500 as shown in FIG. 6, though the second problem is not a drawback of the copper-molybdenum alloy plate itself. In order to solve this problem, for example, means for directly cooling the copper-molybdenum alloy plate 6 by using a liquid has been considered.

However, in a case where the copper-molybdenum alloy plate is directly cooled by using the liquid, it is required that a configuration of a cooling unit be examined. Here, a general radiator for an automobile engine is made of an aluminum alloy. In view of corrosion of aluminum, it is difficult to cause the radiator for an automobile engine to function as a radiator for the heat dissipation structure for a semiconductor device. Further, also considered is a countermeasure that a radiator which is made of copper and dedicated to the heat dissipation structure for the semiconductor device is configured. However, not only such a countermeasure incurs an increase in a weight thereof but also it is difficult to employ the above-mentioned countermeasure for a passenger automobile except for a large-size vehicle or the like which has enough space therein.

In order to solve the above-mentioned first problem, it has been proposed that as a material of the heat spreader, a composite material of aluminum or an aluminum alloy and silicon carbide particles is used, instead of the copper-molybdenum alloy plate. Even in a case where this material is used, a surface of the composite material is, for example, nickel-plated in order to ensure joining performance of soldering layers. However, when this material is used, it is difficult to expose an interface between the silicon carbide particles and the aluminum or the aluminum alloy on the surface of the composite material and it is difficult to evenly form a plating layer on the surface thereof due to an influence exerted by pores caused by shedding of the silicon carbide particles or the like. Therefore, since there arises, for example, a problem that after the soldering layers have been formed, a large number of voids which are considered to be caused by imperfection of the plating layers remain inside the soldering layers, this composite material has not been in widespread use.

A member for a semiconductor device for solving these problems has been proposed in International Application Published under the Patent Cooperation Treaty WO 2006/077755 (Patent Document 1). This member for the semiconductor device comprises a base material and surface layers joined onto both side surfaces of the base material; the base material is made of an aluminum and silicon carbide composite material in which particulate silicon carbide is dispersed in aluminum or an aluminum alloy and whose starting material is a powder material; and the surface layers contain the aluminum or the aluminum alloy whose starting material is a ingot material. Since the plating layers of this member for the semiconductor device are formed on the surface layers of the aluminum or the aluminum alloy which is the ingot material, the plating layers having a high grade can be formed, thereby allowing a drastic reduction of the voids remaining in the soldering layers. In addition, this member for a semiconductor device is capable of solving the above-mentioned second problem. Since the surface layers of the aluminum or aluminum alloy which is the ingot material are present, it is expected that a heat dissipation structure for a semiconductor device, in which a heat spreader is directly cooled, is made available in a form in which a radiator for this member for a semiconductor device is caused to function as a radiator for an automobile engine.

In a transport machine such as an electric train and an electric automobile, it is required to save space by further downsizing a power device such as an IGBT and to increase an output of the power device. In order to cope with such requirements, it is required to further enhance heat dissipation performance per unit area of a heat spreader.

It has been well-known that in a case where physical properties, such as a heat conductivity, of the heat dissipation member are limited due to properties of a material of a heat dissipation member, it is effective to expand a heat dissipation area in order to enhance heat dissipation performance and in general, shapes of fins or pins are adopted to be formed on a heat dissipation surface. It has been attempted that fines or pins are formed also on the heat dissipation member made of the composite material of the aluminum or the aluminum alloy and the silicon carbide particles.

In addition, it has been proposed, for example, in Japanese Patent No. 3692437 (Patent Document 2) and Japanese Patent Application Laid-Open Publication No. 2005-121345 (Patent Document 3) that in order to manufacture a heat sink or a plate-type heat pipe, which includes pin-shaped fins, a plurality of pin-shaped fins are stud-welded on an aluminum material or an aluminum alloy material.

Patent Document 1: International Application Published under the Patent Cooperation Treaty WO 2006/077755

Patent Document 2: Japanese Patent No. 3692437

Patent Document 3: Japanese Patent Application Laid-Open Publication No. 2005-121345

### DISCLOSURE OF THE INVENTION

### Problems to be Solved by the Invention

Therefore, it is considered that a member comprising, as materials of a heat spreader, a base material made of a composite material containing aluminum and silicon carbide and surface layers, including aluminum or an aluminum alloy, which are joined to both side surfaces of the base material is used and a plurality of pin-shaped fins are joined to the surface layers through stud welding. However, when it is attempted that the plurality of pin-shaped fins are joined to the surface layers through the stud welding, it is difficult to obtain a structure having a joining strength practical for the material of the heat spreader. In particular, even when the heat spreader is incorporated into the heat dissipation structure for a semiconductor device, in which direct cooling is performed by using water, it is difficult to join a multitude of pin-shaped fins so as to avoid fractures thereof.

Therefore, objects of the present invention are to provide a heat spreader for a semiconductor device which can be joined so as to prevent a multitude of pin-shaped fins from easily fracturing even when the heat spreader for a semiconductor device is incorporated into a heat dissipation structure for a semiconductor device, in which direct cooling is performed by using water and to provide a method for manufacturing the heat spreader for a semiconductor device.

### Means for Solving the Problems

A heat spreader for a semiconductor device according to the present invention comprises: a plate-like member having one surface and the other surface opposite to the one surface; a plurality of columnar members joined onto at least the one surface of the plate-like member; and a joining layer formed between the plate-like member and the columnar members. The plate-like member includes a base material and surface layers joined onto both side surfaces of the base material. A linear expansion coefficient of the plate-like member is greater than or equal to 3×10⁻⁶/K and less than or equal to 16×10⁻⁶/K and a heat conductivity of the plate-like member is greater than or equal to 120 W/m·K. The surface layers are made of a material containing aluminum or an aluminum alloy and the columnar members are made of a material containing aluminum or an aluminum alloy. A thickness of the plate-like member is greater than or equal to 0.5 mm and less than or equal to 6 mm, and a thickness of each of the surface layers is greater than or equal to 0.1 mm and less than or equal to 1 mm. The joining layer has a joining interface on a boundary with the plate-like member. A proportion of an area of the joining interface being present in the surface layer is greater than or equal to 50% and less than or equal to 100%, converted in terms of a plane projected to the one surface of the plate-like member.

The heat spreader for a semiconductor device according to the present invention, configured as described above, achieves not only a high heat conductivity which allows heat generated by a semiconductor device to be effectively dissipated but also thermal expansion properties close to those of a material of an insulating substrate to prevent a thermal stress fracture caused by a change in a temperature of the mounted semiconductor device. Since the columnar members made of the material containing the aluminum or the aluminum alloy are joined onto the plate-like member with the above-mentioned limited proportion of the area of the joining interface, even when the heat spreader for a semiconductor device according to the present invention is incorporated into a heat dissipation structure for a semiconductor device, in which direct cooling is performed by using water, a multitude of pin-shaped fins are joined thereonto so as to avoid easy fracturing.

In the heat spreader for a semiconductor device according to the present invention, it is preferable that the material of the surface layers is more electrically noble than the material of the columnar members. This allows the columnar members to be more preferentially corroded than the surface layer, thereby making it possible to enhance long-term reliability against the corrosion.

In this case, it is preferable that an aluminum content of the material containing aluminum or the aluminum alloy and used for forming the surface layers is higher than an aluminum content of the material containing the aluminum or the aluminum alloy and used for forming the columnar members. This allows the columnar members to be more preferentially corroded than the surface layer, thereby making it possible to enhance the long-term reliability against the corrosion.

In addition, in this case, it is preferable that a crystal grain size of the aluminum or the aluminum alloy used for forming the surface layers is greater than a crystal grain size of the aluminum or the aluminum alloy used for forming the columnar members. Since this allows the columnar members to be more preferentially corroded than the surface layer, the surface layers become more electrically noble than the columnar members because of the later-described definition, thereby making it possible to enhance the long-term reliability against the corrosion.

In the heat spreader for a semiconductor device according to the present invention, it is preferable that a starting material of the base material is a powder material.

A member for a semiconductor device according to the present invention comprises the heat spreader for a semiconductor device, which has at least the above-mentioned features.

In a method for manufacturing the heat spreader for a semiconductor device according to the present invention, comprising the step of joining columnar members onto at least one surface of a plate-like member by employing a stud welding method such that a proportion of an area of a joining interface being present in a surface layer is greater than or equal to 50% and less than or equal to 100%, converted in terms of a plane projected to the one surface of the plate-like member.

In the method for manufacturing the heat spreader for a semiconductor device according to the present invention, it is preferable that a crystal grain size of aluminum or an aluminum alloy used for forming the surface layers is increased by heating at least the surface layers before the step of joining the columnar members onto at least the one surface of the plate-like member by employing the stud welding method.

In addition, in the method for manufacturing the heat spreader for a semiconductor device according to the present invention, it is preferable that a crystal grain size of aluminum or an aluminum alloy used for forming surface layers is increased by heating at least the surface layers after the step of joining the columnar members onto at least the one surface of the plate-like member by employing the stud welding method.

### EFFECT OF THE INVENTION

As described above, according to the present invention, obtained is a heat spreader for a semiconductor device in which a multitude of pin-shaped fins are joined so as to avoid easy fracturing even when the heat spreader for a semiconductor device is incorporated into a heat dissipation structure for a semiconductor device, in which direct cooling is performed by using water.

### BRIEF DESCRIPTION OF THE DRAWINGS

FIG. 1 is a schematic sectional view of a heat spreader as one embodiment of the present invention.

FIG. 2 is schematic partial sectional view which shows one form of a joining portion of each of the columnar members in the heat spreader according to the embodiment of the present invention.

FIG. 3 is schematic partial sectional view which shows another form of a joining portion of each of the columnar members in the heat spreader according to the embodiment of the present invention.

FIG. 4 is a schematic diagram illustrating a heat dissipation structure for a semiconductor device, in which the heat spreader as the one embodiment of the present invention is used.

FIG. 5 is a schematic diagram illustrating a heat dissipation structure for a semiconductor device, in which a heat spreader as another embodiment of the present invention is used.

FIG. 6 is a schematic diagram illustrating a heat dissipation structure for a semiconductor device, in which a conventional heat spreader is used.

### EXPLANATION OF REFERENCE NUMERALS

1: heat spreader, 11: base material, 12: surface layer, 13: columnar member.

### BEST MODE FOR CARRYING OUT THE INVENTION

With respect to a heat spreader for a semiconductor device which can be joined so as to prevent a multitude of pin-shaped fins from easily fracturing even when the heat spreader for a semiconductor device is incorporated into a heat dissipation structure for a semiconductor device, in which direct cooling is performed by using water and a method for manufacturing the heat spreader for a semiconductor device, the inventors have devoted themselves to studies. As a result, the inventors found that a proportion of an area of a joining interface between columnar members as pin-shaped fins and a surface layer influences a joining strength of the columnar members. Based on such findings, the present invention was made.

First, a configuration on which a heat spreader for a semiconductor device according to the present invention is premised will be described.

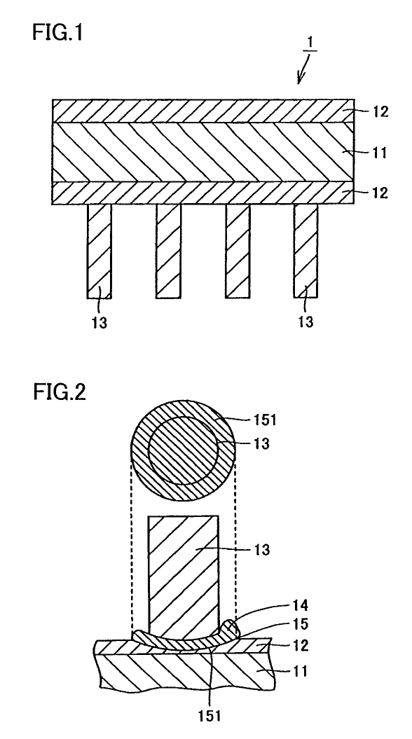

FIG. 1 is a schematic sectional view of the heat spreader as one embodiment of the present invention.

As shown in FIG. 1, the heat spreader for a semiconductor device 1 comprises: a plate-like member having one surface and the other surface opposite to the one surface; a plurality of columnar members 13 which are joined onto at least one of the one surface and the other surface of the plate-like member and are, for example, a multitude of pin-shaped fins; and a joining layer formed between the plate-like member and the columnar members 13. The plate-like member includes a base material 11 and surface layers 12 joined onto both side surfaces of the base material 11. A linear expansion coefficient of the plate-like member is greater than or equal to 3×10⁻⁶/K and less than or equal to 16×10⁻⁶/K and a heat conductivity of the plate-like member is greater than or equal to 120 W/m·K. The surface layers 12 are made of a material containing aluminum or an aluminum alloy, and the columnar members 13 are made of the material containing the aluminum or the aluminum alloy. A thickness of the plate-like member is greater than or equal to 0.5 mm and less than or equal to 6 mm, and a thickness of each of the surface layers 12 is greater than or equal to 0.1 mm and less than or equal to 1 mm. The joining layer has a joining interface on a boundary with the plate-like member. A proportion of an area of the joining interface being present in the surface layer is greater than or equal to 50% and less than or equal to 100%, converted in terms of a plane projected to the one surface of the plate-like member. The joining layer will be described later.

Since in the heat spreader 1 having the above-described configuration, the surface layers 12 of the plate-like member contain the aluminum or the aluminum alloy, a nickel-plated layer having a high grade can be formed on a desired surface, and in a case where the surface of the surface layers 12, onto which the columnar members 13 are joined, is cooled by using water, it is made possible to cause an existing radiator in a passenger automobile to function also as a radiator for a heat dissipation structure for a semiconductor device. In addition, in a case where the surface of the surface layers 12, onto which the columnar members 13 are joined, is plated, plating having a high grade can be implemented and reliability for causing the existing radiator in a passenger automobile to function also as the radiator for the heat dissipation structure for a semiconductor device can be enhanced.

Since a material of a substrate of a semiconductor device, such as an IGBT, which is mounted on the heat spreader is silicon, a lower limit of the linear thermal expansion coefficient of the plate-like member is supposed to be 3×10⁻⁶/K equivalent to that of the silicon. In general, a greatest thermal stress is imposed upon soldering and a difference between a melting point of currently prevailing lead-free solder and a room temperature is approximately 200° C. through 250° C. In a case where a linear expansion coefficient of the plate-like member is less than 3×10⁻⁶/K, a tensile residual stress remains in the silicon of which the substrate of a semiconductor device such as an IGBT is made, the silicon being a brittle material. This is not favorable from a viewpoint of reliability. An upper limit of the linear thermal expansion coefficient of the plate-like member varies depending on a kind of a semiconductor device mounted on the heat spreader. In a case where the IGBT or the like of which high heat dissipation performance is required is mounted on the heat spreader, the upper limit is required to be less than or equal to 12×10⁻⁶/K in order to avoid any fracture of the silicon of which the substrate is made, though depending on dimensions and a configuration of the plate-like member. However, when it is only required that heat generated by other general semiconductor device is dissipated, the upper limit may be less than or equal to 16×10⁻⁶/K equivalent to a linear expansion coefficient of copper.

A minimum requirement of the heat conductivity of the plate-like member is greater than or equal to 120/m·K. If a heat conductive property is less than or equal to 120/m·K, it is difficult to employ such a material of the plate-like member as the material of the heat spreader. It is preferable that a heat conductivity of the plate-like member is greater than or equal to 150 W/m·K and it is more preferable that a heat conductivity of the plate-like member is greater than or equal to 180 W/m·K. It is not particularly required to set the upper limit of the heat conductivity of the plate-like member. However, a material having a greatest heat conductivity at present is a diamond, and it is said that a heat conductivity of the diamond is greater than or equal to 1000 W/m·K. If the base material 11 sandwiched by the surface layers 12 containing the aluminum or the aluminum alloy is made by using the diamond without considering a cost, it is considered that a heat conductivity close to 1000 W/m·K can be obtained.

However, when a cost is realistically considered, it is preferable that as the base material 11, a composite material which contains the aluminum or the aluminum alloy as a matrix and has silicon carbide particles dispersed in the matrix is used. Since the silicon carbide particles are used as a grinding agent or the like, the silicon carbide particles are mass-produced through the Acheson process or the like and a manufacturing cost thereof is low, as compared with those of additives for other composite materials. In addition, this material can be designed so as to adjust a linear thermal expansion coefficient in accordance with an added amount of the silicon carbide particles. In other words, in a case where the aluminum is used as the matrix, when an added amount of the silicon carbide particles is 20% by mass, a linear expansion coefficient is approximately 16×10⁻⁶/K; when an added amount of the silicon carbide particles is 40% by mass, a linear expansion coefficient is approximately 14×10⁻⁶/K; when an added amount of the silicon carbide particles is 60% by mass, a linear expansion coefficient is approximately 9×10⁻⁶/K; and when an added amount of the silicon carbide particles is 80% by mass, a linear expansion coefficient is approximately 6×10⁻⁶/K. However, it is difficult to obtain a linear expansion coefficient of this material, which is less than 6×10⁻⁶/K, since a content of the silicon carbide particles is greater than or equal to 80% by mass. For this reason, a lower limit of the linear expansion coefficient of the plate-like member, which includes: the base material 11 made of the composite material containing the aluminum or aluminum alloy used as the matrix and having the silicon carbide particles dispersed in the matrix; and the surface layers 12 containing the aluminum or the aluminum alloy, is 6×10⁻⁶/K. On the other hand, an upper limit varies depending on the kind of the semiconductor device mounted on the heat spreader, as mentioned above. In particular, in a case where the IGBT of which the high heat dissipation performance is required is mounted on the heat spreader, the upper limit is required to be less than or equal to 12×10⁻⁶/K.

Note that in addition to the silicon carbide particles, for example, an additive such as carbon fibers is added, whereby the above-described linear expansion coefficient of the plate-like member can be adjusted. This refinement is intrinsically embraced in the scope of the present invention.

A thickness of the plate-like member included in the heat spreader 1 is greater than or equal to 0.5 mm and less than or equal to 6 mm. In a case where a thickness of the plate-like member is less than 0.5 mm, not only heat is not conducted into the surface of the plate-like member and thereby, the plate-like member hardly functions as the heat spreader but also stiffness is small and local heating easily causes waviness of the plate. In a case where a thickness of the plate-like member is greater than 6 mm, although heat conduction into the surface of the plate-like member is favorable, a thermal gradient in a through-thickness direction is reduced, a temperature under the semiconductor device generating heat hardly falls, a thermal runaway or the like of the semiconductor device is likely to occur. A plate thickness optimum for the heat spreader for a power device is greater than or equal to 2 mm and less than or equal to 5 mm.

It is preferable that among the above-mentioned thicknesses of the plate-like member, a thickness of one side of the surface layers 12, which is present in the surface of the plate-like member, is greater than or equal to 0.1 mm. In a case where the thickness of the one side of the surface layers 12 is small, a practical strength as a strength of joining to the columnar members 13 cannot be obtained. On the other hand, an upper limit of the thickness of each of the surface layers 12 required when the columnar members 13 are joined is not limited.

As described, it has been known, as proposed in, for example, Japanese Patent No. 3692437 (Patent Document 2) and Japanese Patent Application Laid-Open Publication No. 2005-121345 (Patent Document 3), that a flat plate made of the aluminum or the aluminum alloy and the pin-shaped fins made of the aluminum or the aluminum alloy can be joined to each other through stud welding. In a case where in the heat spreader 1 according to the present invention, a proportion of the surface layers 12 made of the aluminum or the aluminum alloy in the plate-like member is great, it is considered that the surface layers 12 are substantially identical to the flat plate of the base material 11 made of the aluminum or the aluminum alloy. This is the heretofore known technology.

However, if in the heat spreader 1 according to the present invention, a thickness of the plate-like member is in a limited range of 0.5 mm through 6 mm and a thickness of each of the surface layers 12 made of the aluminum or the aluminum alloy is great, since a linear expansion coefficient of each of the surface layers 12 made of the aluminum or the aluminum alloy is great, approximately 23×10⁻⁶/K, a property of the plate-like member including the surface layers 12 made of the aluminum or the aluminum alloy is greater than 16×10⁻⁶/K which is the upper limit of the linear expansion coefficient. An upper limit of the thickness of each of the surface layers 12 made of the aluminum or the aluminum alloy, which is 1 mm, is solely a maximum value which does not exceed 6 mm as the upper limit of the thickness of the plate-like member and is used as a reference value in a case where 16×10⁻⁶/K as the upper limit of the linear expansion coefficient is satisfied. In order to avoid an increase in a linear expansion coefficient of the plate-like member, it is preferable that a thickness of each of the surface layers 12 made of the aluminum or the aluminum alloy is greater than or equal to 0.1 mm and less than or equal to 0.4 mm. If a thickness of each of the surface layers 12 exceeds 0.4 mm, a joining strength of the columnar members 13 is saturated.

A shape of each of the columnar members 13 joined to the plate-like member is not particularly limited, and a cylindrical shape, a conical shape, a polygonal column shape, polygonal pyramid shape, or any combination of these may be adopted. However, in order to obtain a cooling effect attained by joining the columnar members 13, it is preferable that a height of each of the columnar members is at least greater than or equal to a diameter equivalent to an area of a joined portion. Even if a height of each of the columnar members is increased so as to be greater than four times the diameter equivalent to the area of the joined portion, the effect attained by joining the columnar members is saturated. In addition, it is preferable that a diameter of each of the columnar members 13 is greater than or equal to 2 mm and less than or equal to 8 mm. In a case where a diameter of each of the columnar members 13 is less than 2 mm, stiffness of the columnar members is low and the columnar members cannot endure a pressure of a fluid upon liquid cooling. In a case where a diameter of each of the columnar members 13 is greater than 8 mm, a cooling efficiency of the whole heat spreader 1 is rather reduced since a thickness of the plate-like member of the heat spreader 1 according to the present invention is 0.5 mm through 6 mm.

Although regarding spacings of the columnar members 13, consideration is required, these vary depending on conditions of use and it is difficult to limit these. The reason for this is that since a semiconductor device is not mounted on a whole plane of the plate-like member of the heat spreader 1, it is difficult to limit the spacings of the columnar members 13 on the whole plane of the plate-like member.

Next, the joining layer has the joining interface on the boundary with the plate-like member. The reason why a proportion of the area of the joining interface being present in the surface layer 12 is set to be greater than or equal to 50% and less than or equal to 100%, converted in terms of the plane projected to the one of the sides of the plate-like member will be described.

The columnar members 12 in the heat spreader 1 according to the present invention are joined to the plate-like member through stud welding. Several methods of the stud welding have been proposed. Basically, employed is a kind of an arc welding method in which a small projection (a diameter of approximately 0.5 mm×a length of approximately 0.7 mm) of a lower portion of a stud is mainly melted by heating caused through applying an electric current and the stud is joined to another material different from the stud. In the present invention, among stud welding methods, a gap method is adopted. In the heat spreader 1 according to the present invention, the stud corresponds to each of the columnar members 12 and the columnar members 12 are joined to the plate-like member through employing the stud welding method.

The inventors noted that in the stud welding method, an influence of a difference between heat expansion coefficients of materials is hardly exerted because a volume of a molten portion is small and a stud as well as a member which is a counterpart joined to the stud can be maintained at a desired ambient temperature, for example, a room temperature, and therefore, the inventors examined the adoption of the stud welding for joining the columnar members in the heat spreader.

As described above, it has been well-known that the flat plate made of the aluminum or the aluminum alloy as well as the pin-shaped fins as the studs made of the aluminum or the aluminum alloy can be joined to each other through the stud welding. However, as described above, even if it is attempted that the plurality of pin-shaped fins are joined to the above-mentioned surface layer through the stud welding, it is difficult to obtain a structure having a joining strength practical for a material of the heat spreader. In particular, it is difficult to join the pin-shaped fins to the surface layer so as to prevent the multitude of the pin-shaped fins from easily fracturing even when the heat spreader for a semiconductor device is incorporated into a heat dissipation structure for a semiconductor device, in which direct cooling is performed by using water. This is because a force from a lateral direction is applied by a liquid or the like for cooling and thereby, a crack is easily caused in the plate-like member immediately below a joining portion of each of the pin-shaped fins as the columnar members, whereby the pin-shaped fins are separated from the plate-like member such that the columnar members are torn away or pulled out inside the plate-like member. In order to prevent the above-mentioned phenomenon, the inventors examined a variety of conditions for the stud welding.

As a result, it was found that when the heat spreader according to the present invention is under a condition that the joining layer (melted portion) formed between the plate-like member and the columnar members through the stud welding has the joining interface on the boundary with the plate-like member and a condition that the proportion of the area of this joining interface being present in the surface layer (including the aluminum or the aluminum alloy) is greater than or equal to 50% and less than or equal to 100%, converted in terms of the plane projected to the one of the sides of the plate-like member is satisfied, even if the force from the lateral direction is applied by the liquid upon the liquid cooling, the columnar members are not torn away or not pulled out, are only deformed, and are retained so as to be joined to the plate-like member.

Here, the proportion of the area of this joining interface being present in the surface layer is defined.

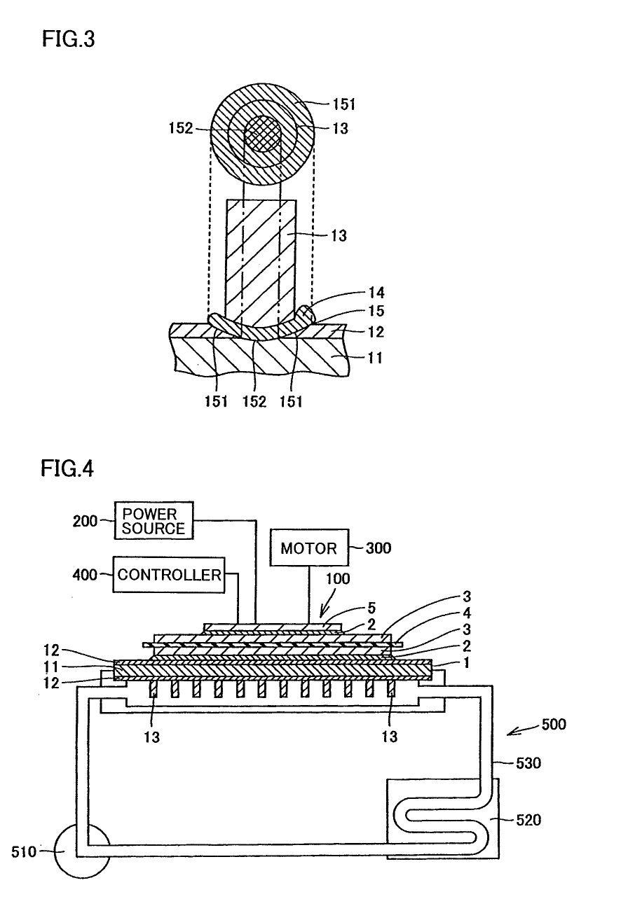

FIG. 2 and FIG. 3 are schematic partial sectional views, each of which shows a joining portion of each of the columnar members in the heat spreader according to the embodiment of the present invention.

As shown in FIG. 2 and FIG. 3, the columnar member 13 is joined to the surface layer 12 on the base material 11 (which is the aluminum and silicon carbide composite material made of the aluminum or the aluminum alloy as the matrix and the multitude of silicon carbide particles dispersed in the aluminum or the aluminum alloy, as one example in this embodiment) included in the plate-like member. Between the plate-like member, which includes the base material 11 and the surface layer 12, and the columnar member 13, a joining layer 14 made of a columnar crystal of the aluminum is formed. The joining layer 14 is a portion obtained by melting a part of the columnar member 13 and thereafter, solidifying the part through the stud welding. The joining layer 14 has a joining interface 15 on a boundary with the plate-like member. In the joining interface 15, a joining interface portion 151 is present in the surface layer 12 and a joining interface portion 152 is present in the base material 11. In FIG. 2, a proportion in which the joining interface 15 is present in the surface layers 12 is 100%, that is, only the joining interface portion 151 constitutes the joining interface 15, and the joining interface portion 151 is shown in an upper part of FIG. 2 as an region to which the joining interface portion 151 is converted in terms of a plane projected to the one surface of the plate-like member, with the region hatched in a diagonally right down manner. In FIG. 3, the joining interface portion 151 present in the surface layers 12 and the joining interface portion 152 present in the base material 11 constitutes the joining interface 15. In an upper part of FIG. 3, a region to which the joining interface portion 151 is converted in terms of the plane projected to the one surface of the plate-like member is shown, with the region hatched in the diagonally right down manner; and an region to which the joining interface portion 152 is converted in terms of the plane projected to the one surface of the plate-like member is shown, with the region cross-hatched. Accordingly, as the proportion of the area of the joining interface 15, which is present in the surface layer 12, the proportion of the area to which the joining interface 15 is converted in terms of the plane projected to the one surface of the plate-like member is a proportion of an area of the region, hatched in the diagonally right down manner as shown in the upper part of FIG. 3, to a total area (an area of the greatest circular region) of the cross-hatched region and the region hatched in the diagonally right down manner as shown in the upper part of FIG. 3. In other words, the proportion of the area of the joining interface 15 which is present in the surface layer 12 is a proportion of an area, calculated by subtracting from a whole area of the joining interface 15 the area of the joining interface portion 152 where the joining interface 15 is present in the base material 11, to the whole area of the joining interface 15, that is, a value (%) obtained by dividing by the whole area of the joining interface 15 the area (an area of the joining interface portion 151) calculated by subtracting from a whole area of the joining interface 15 the area of the joining interface portion 152 where the joining interface 15 is present in the base material 11.

Specifically, when a structure of each of cross sections corresponding to those shown in FIG. 2 and FIG. 3 was observed by using an appropriate etchant such as a 3% hydrofluoric acid solution, a portion which was melted and thereafter, solidified upon the stud welding was perceived to be a region of the columnar crystal as the joining layer 14, and the joining interface 15 was seen as a boundary line between this region of the columnar crystal and the plate-like member. The proportion of the area of the joining interface 15 which is present in the surface layer 12 can be calculated based on the joining interface 15 as this boundary line. Accordingly, as shown in FIG. 2, in a case where the whole of the joining interface 15 as this boundary line is present in the surface layer 12, a proportion of an area of the joining interface 15, which is present in the surface layer 12, is 100%.

In order that a proportion of an area of the joining interface 15 which is present in the surface layer 12 is greater than or equal to 50%, it is required that the surface layer 12 made of the aluminum or the aluminum alloy, which has a thickness greater than or equal to 0.1 mm, is formed on the surface of the base material 11. In addition, in a case where the surface layer 12 made of the aluminum or the aluminum alloy, which has a thickness greater than or equal to 0.4 mm, is formed on the surface of the base material 11, a proportion of an area of the joining interface 15, which is present in the surface layer 12, is 100%.

Note that upon joining the columnar members 13, the surface layer 12 may be subjected to metal plating, such as nickel plating, having a thickness less than or equal to ten and several μm.

Here, in a case where the base material 11 is made of a composite material prepared by a powder method, for example, the aluminum and silicon carbide composite material made of the aluminum or the aluminum alloy as the matrix and the multitude of silicon carbide particles dispersed in the aluminum or the aluminum alloy, the base material 11 has voids or the like thereinside. When upon the stud welding, the aluminum or the aluminum alloy, of which the columnar members 13 are made, is melted, spatters of surplus melted aluminum or aluminum alloy are formed on a periphery or the like of each of the columnar members 13. When due to a capillary permeation phenomenon, this surplus melted aluminum or aluminum alloy permeates into portions in the base material 11, where the voids are present, an effect of reducing the formation of the above-mentioned spatters is exhibited. Therefore, in a case where the composite material prepared by employing the power method is used as the base material 11, the heat spreader 1 having few spatters can be obtained rather by setting the proportion of the area of the joining interface 15, which is present in the surface layer 12, not to be 100%, that is, by setting a thickness of the surface layer 12 to be approximately 0.1 mm through 0.35 mm so as to cause a part of the joining interface 15 to be present in the base material 11. Reducing an amount of the formation of the spatters as described above not only allows a fine appearance to be obtained but also brings about an advantage in view of reliability against corrosion of the spatters, that is, enhancement of an anti-corrosion characteristic, which is attained by reducing separation or the like of the spatters.

Next, an anti-corrosion characteristic of the heat spreader according to the present invention will be described. In order to enhance reliability against corrosion in the heat spreader according the present invention, first, it is preferable that a material of the surface layers 12 is more electrically noble than a material of the columnar members 13. In this case, it is preferable that a content of aluminum in a material containing the aluminum or the aluminum alloy, of which the surface layers 12 are formed, is greater than a content of aluminum in a material containing aluminum or an aluminum alloy, of which the columnar members 13 are formed. In addition, in this case, it is preferable that a crystal grain size of the aluminum or the aluminum alloy, of which the surface layers 12 are formed, is greater than a crystal grain size of the aluminum or the aluminum alloy, of which the columnar members are formed. Further, in a method for manufacturing the heat spreader according to the present invention, in order to enhance the reliability against the corrosion, it is preferable that before joining the columnar members 13 onto at least one of the surfaces of the plate-like member by employing the stud welding, the crystal grain size of the aluminum or the aluminum alloy, of which the surface layers 12 are formed, is increased by heating at least the surface layers 12. In addition, in the method for manufacturing the heat spreader, it is preferable that after joining the columnar members 13 onto at least the one of the surfaces of the plate-like member by employing the stud welding method, the crystal grain size of the aluminum or the aluminum alloy, of which the surface layers 12 are formed is increased by heating at least the surface layers 12.

Hereinafter, these features will be described.

By making the material of the columnar members 13 made of the aluminum or the aluminum alloy less electrically noble than the material of the surface layers 12 made of the aluminum or the aluminum alloy, long-term reliability against the corrosion can be enhanced. Here, being less electrically noble will be defined. In a strict sense, when two kinds of the aluminum or the aluminum alloy are immersed in a liquid medium in contact therewith under a use environment, one of the two kinds thereof, which is preferentially corroded, is defined as being less electrically noble than the other of the two kinds thereof. In a broad sense, when an appropriate etchant (for example, a 5% sodium chloride aqueous solution, etc.) is selected by conducting an accelerated test or the like and the two kinds of the aluminum or the aluminum alloy are immersed in the etchant in contact therewith, one of the two kinds, which is preferentially corroded, is defined as being less noble than the other of the two kinds thereof.

In order to decrease a linear expansion coefficient of a whole of the plate-like member, it is preferable that the surface layers 12 made of the aluminum or the aluminum alloy are made thin. However, when the surface layers 12 are thin, through-bores which penetrate through the surface layers 12 may be easily formed due to the corrosion. In a case where the through-bores are formed, a more inside part of the base material 11 than the surface layers 12 are exposed to a corrosion environment, and in particular, in a case where the material of the base material 11 is less noble than the aluminum or the aluminum alloy, of which the surface layers 12 are formed, or than the aluminum or the aluminum alloy, of which the columnar members 13 are formed, the corrosion is further promoted, thereby causing a problem such as a liquid leakage.

In a case where the base material 11 is made of a composite material, manufactured by employing a melting method, which is, for example, an aluminum and silicon carbide composite material made of aluminum or an aluminum alloy as a matrix and a multitude of silicon carbide particles dispersed in the aluminum or the aluminum alloy, a casting aluminum alloy, such as an alloy having a JIS alloy number AC4C, which has high contents of silicon and copper and is rich in additional elements is used, for example, because of its easiness of casting and for a purpose of inhibiting reaction of the silicon carbide particles. On the other hand, in general, it is often the case that as the aluminum or the aluminum alloy, of which the surface layers 12 are formed, wrought aluminum or a wrought aluminum alloy is used. The casting aluminum alloy has a higher concentration of the additional elements, has a lower purity of the aluminum, and less noble than the wrought aluminum or the wrought aluminum alloy. In such a case, after through-bores have been formed in the surface layers 12 due to corrosion, corrosion of the composite material of which the base material 11 is formed markedly develops.

In contrast to this, in a case where the base material 11 is made of the composite material, manufactured by employing the powder method, which is, for example, the aluminum and silicon carbide composite material made of the aluminum or the aluminum alloy as the matrix and the multitude of silicon carbide particles dispersed in the aluminum or the aluminum alloy, it is easy to make a purity of the aluminum of the matrix equivalent to a purity of the aluminum of the surface layers 12 or make the purity of the aluminum of the matrix greater than or equal to the purity of the aluminum of the surface layers 12, thereby allowing reliability against the corrosion to be enhanced.

In addition, the joining layer 14 formed through the stud welding has a structure which has been melted and then solidified. Therefore, even if the same kind of the aluminum or the aluminum alloy is used as the materials of the surface layers 12 and the columnar members 13, segregation of a solute element or the like easily occurs on a grain boundary of a columnar crystalline region of the joining layer 14, and it can be said that the joining layer 14 is a portion which is easily corroded.

As a countermeasure against this, by making the material of the columnar members 13 less noble than the material of the surface layers 12, not only the surface layers 12 can be protected from the corrosion due to a sacrificial anode effect but also the joining layer 14 is also protected from the corrosion since a composition of the joining layer 14 becomes a composition intermediate between the columnar members 13 and the surface layers 12.

Note that also by making one part of the material of the columnar members 13 less electrically noble than the other part of the material of the columnar members 13 and the material of the surface layers 12, the same effect as mentioned above can be obtained.

A portion acting as a starting point at which the corrosion starts occurring is in a columnar crystalline region. Therefore, for a purpose of reducing such starting points at which the corrosion starts occurring, in the heat spreader 1 according to the present invention, grain coarsening of the aluminum or the aluminum alloy, of which the surface layers 12 are formed, is also effective in order to enhance the reliability against the corrosion.

Here, the crystal grain size will be defined. The crystal grain size is defined as an equivalent diameter of each of crystal grains which are located on a surface contacting a liquid medium or the like for cooling. An actual measurement is conducted such that the above-mentioned surface is etched by an appropriate etchant such as a sodium hydroxide aqueous solution and thereafter, the crystal grains, each of which is within a specified area, are measured. Each of the crystal grains, which completely fits in the specified area, is counted as 1 and each of the crystal grains, which does not completely fit in the specified area, is counted as 0.5. The crystal grain size is obtained by converting, in terms of a diameter, an area which is calculated by diving the specified area by a total number of counts and is supposed as a circle.

It is preferable that the crystal grain size of the aluminum or the aluminum alloy, of which the surface layers 12 are formed, is greater than or equal to 6 mm. In a case where the crystal grain size is greater than or equal to 6 mm, the corrosion of the surface layers 12 is greatly delayed, as compared with a case where the crystal grain size is smaller than 6 mm. On the other hand, regarding an upper limit of the crystal grain size, it is considered that the greater the crystal grain size is, the better and ultimately, a single crystal is the best. However, the reality is that it is difficult to grow a crystal grain, which has a crystal grain size exceeding 30 mm, in the surface layers 12 having a thickness of 0.3 mm.

By making a crystal grain size of the aluminum or the aluminum alloy, of which the columnar members 13 are formed, to be smaller than a crystal grain size of the aluminum or the aluminum alloy, of which the surface layers 12 are formed, an effect like a sacrificial anode effect can be obtained. In addition, since a material thickness of each of the columnar members 13 is greater than a material thickness of each of the surface layers 12, the columnar members 13 are resistant to the corrosion. Therefore, causing the columnar members 13 to be first corroded rather allows an anti-corrosion characteristic as a whole to be enhanced. In addition, in a case where a crystal grain boundary is decreased, since a dislocation density exerts an influence on the corrosion, it is preferable that the dislocation density is low.

It is possible to use the above-mentioned countermeasures against the corrosion in combination.

Regarding a specific example in which the material of the columnar members 13 is less electrically noble than the material of the surface layers 12 into which the columnar members 13 are joined, it is preferable that an aluminum content (aluminum purity) of the aluminum or the aluminum alloy, of which the surface layers 12 are formed, is higher than an aluminum content of the aluminum or the aluminum alloy, of which the columnar members 13 are formed. If the material of the surface layers 12 is an aluminum alloy whose JIS alloy number (international aluminum alloy name) is A1070 (an aluminum purity is greater than or equal to 99.70% by mass), it is only required to use as the material of the columnar members 13, for example, an aluminum alloy whose JIS alloy number is A1050 (an aluminum purity is greater than or equal to 99.50% by mass) and which has the purity lower than the purity of the material of the surface layers 12. In addition, if the material of the surface layers 12 is an aluminum alloy whose JIS alloy number (international aluminum alloy name) is A5005, it is only required to use as the material of the columnar members 13, for example, an aluminum alloy whose JIS alloy number is A5052 and which has a purity lower than the purity of the material of the surface layers 12.

Furthermore, the one part of the material of the columnar members 13 may be made less electrically noble than the other part of the material of the columnar members 13 and the material of the surface layers 12. For example, as the columnar members 13, composite columnar members may be used, each of which is obtained through preparing a composite material which is prepared by pipe-fitting a pipe having an outside diameter of 8 mm and an inside diameter of 6 mm and made of an aluminum alloy whose JIS alloy number is A1050 and a round bar having an outside diameter of 5 mm and made of an aluminum alloy whose JIS alloy number is A5005, through wiredrawing, with a wire drawing die, the prepared composite material so as to allow an outside diameter thereof to be 4 mm, and through processing the wiredrawn composite material with a lathe.

In the method for manufacturing the heat spreader, the structure of the aluminum of the aluminum alloy, of which the surface layers 12 are formed, is adjusted through heat treatment, thereby also allowing the anti-corrosion characteristic of the heat spreader to be enhanced. This is a method for reducing the crystal grain boundary which tends to become a starting point of the corrosion.

As a first method, before the columnar members 13 are joined onto said at least one of the surfaces of the plate-like member by employing the stud welding method, the crystal grains of the aluminum or the aluminum alloy, of which the surface layers 12 are formed, are grown by heating at least the surface layers 12, and it is only required to make a crystal grain size thereof, specifically, greater than or equal to 6 mm. As a heating temperature applied this time, a temperature higher than a general recrystallization temperature (industrially-used softening temperature, which is a softening temperature of many wrought aluminum alloys, for example, 345° C. through 415° C.) is adopted and it is recommended to adopt a temperature which allows the crystal grains to be grown. For example, if the material of which the surface layers 12 are formed is the aluminum alloy whose JIS alloy number is A1050, it is only required that the heat treatment is performed at a temperature of 550° C. through 650° C.

As a second method, after the columnar members 13 have been joined onto said at least one of the surfaces of the plate-like member by employing the stud welding method, the crystal grains of the aluminum or the aluminum alloy used, of which the surface layers 12 are formed, are grown by heating at least the surface layers 12, and it is only required to make a crystal grain size thereof, specifically, greater than or equal to 6 mm.

In addition, as described above, since a dislocation or the like in the crystal grain exerts an influence on the corrosion, it is preferable in order to reduce the dislocation that the second method rather than the first method is adopted.

In order to enhance the anti-corrosion characteristic of the heat spreader, both of the first and second methods may be performed.

Regarding the above-described various countermeasures against the corrosion, electrochemical states of being noble or less noble and structure control can be utilized in combination. In such a case, it is only required to effectively utilize a heretofore known anti-corrosion characteristic enhancement effect attained by, for example, adding a minor element to the aluminum or the aluminum alloy.

FIG. 4 is a schematic diagram illustrating a heat dissipation structure for a semiconductor device, in which the heat spreader as the one embodiment of the present invention is used.

As shown in FIG. 4, electrically connected to a power device unit 100 are a power source 200, a motor 300, and a controller 400. In the power device unit 100, aluminum layers 3 (or copper layers) are formed on both side surfaces of an insulating substrate 4 made of aluminum nitride, silicon nitride, alumina, or the like. On one of the surfaces of the insulating substrate 4 on which the aluminum layers 3 are formed, a semiconductor device (chip) 5 is mounted with a soldering layer 2 interposed therebetween. On the other of the surfaces of the insulating substrate 4 on which the aluminum layers 3 are formed, a heat spreader 1 as the one embodiment of the present invention is joined with a soldering layer 2 interposed therebetween. In order to ensure joining performance of the soldering layer, one of surfaces of one of the surface layers 12 of the plate-like member included in the heat spreader 1, on a side on which the insulating substrate 4 is joined, is nickel-plated. Similarly, a surface of the aluminum layer 3 on the surface of the insulating substrate 4, on which the soldering layer 2 is interposed, is also nickel-plated. On a surface of the heat spreader 1, on a side on which a multitude of columnar members 13 which are pin-shaped fins are joined, a cooling unit 500 is attached. Inside the cooling unit 500, a coolant circulation channel 530 for circulating water or other liquid as a coolant by a pump 510 is formed. The liquid inside the coolant circulation channel 530 is arranged so as to directly contact surfaces of the multitude of columnar members 13 formed on the heat spreader 1. Since the cooling unit 500 includes a radiator 520, heat is eventually vented to the atmosphere. The heat spreader 1 having the multitude of columnar members 13 serves to conduct local heat generated by the semiconductor device 5 to the coolant circulation channel 530 in the cooling unit 500.

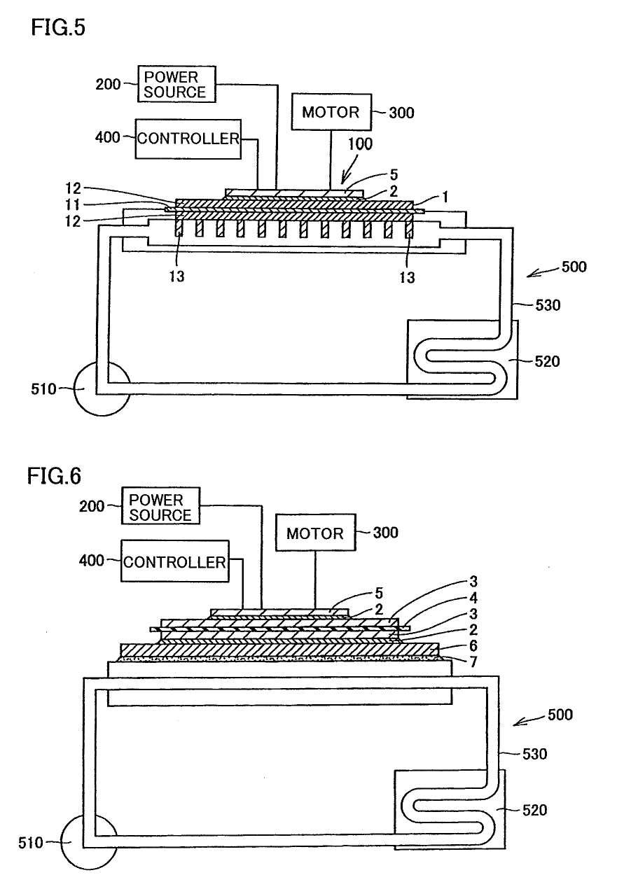

FIG. 5 is a schematic diagram illustrating a heat dissipation structure for a semiconductor device, in which a heat spreader as another embodiment of the present invention is used.

As shown in FIG. 5, electrically connected to a power device unit 100 are a power source 200, a motor 300, and a controller 400. In this power device unit 100, on the heat spreader 1, a semiconductor device (chip) 5 is mounted on one of surfaces of a base material 11 on which surface layers 12 are formed with a soldering layer 2 interposed therebetween. In order to ensure joining performance of the soldering layer, one of surfaces of one of the surface layers 12 of the plate-like member included in the heat spreader 1, on a side on which the semiconductor device (chip) 5 is joined, is nickel-plated. On the other of the surfaces of the base material 11, on which the surface layers 12 are formed, a multitude of columnar members 13 which are pin-shaped fins are joined. On a surface of the heat spreader 1, on a side on which the multitude of columnar members 13 are joined, a cooling unit 500 is attached. Inside the cooling unit 500, a coolant circulation channel 530 for circulating water or other liquid as a coolant by a pump 510 is formed. The liquid inside the coolant circulation channel 530 is arranged so as to directly contact surfaces of the multitude of columnar members 13 formed on the heat spreader 1. Since the cooling unit 500 includes a radiator 520, heat is eventually vented to the atmosphere. The heat spreader 1 having the multitude of columnar members 13 serves to conduct local heat generated by the semiconductor device 5 to the coolant circulation channel 530 in the cooling unit 500.

In the embodiment shown in FIG. 4, it is preferable that as a material of the base material 11 included in the heat spreader 1, an aluminum and silicon carbide composite material made of aluminum or an aluminum alloy as a matrix and a multitude of silicon carbide particles dispersed in the aluminum or the aluminum alloy is adopted. In addition, in the embodiment shown in FIG. 5, it is preferable that as a material of the base material 11 included in the heat spreader 1, an aluminum nitride sintered body, a silicon nitride sintered body, aluminum oxide sintered body, a silicon and silicon carbide composite material made of silicon as a matrix and a multitude of silicon carbide particles dispersed in the silicon, or the like is adopted.

As shown in FIG. 4 and FIG. 5, by adopting the heat spreader 1 according to the present invention, a heat dissipation structure for a semiconductor device for directly cooling the heat spreader by using water can be realized in a form in which a radiator for an automobile engine is caused to function as the heat dissipation structure. In addition, in a transport machine such as an electric train and an electric automobile, it is required to save a space by further downsizing a power device such as an IGBT and to increase an output of the power device. In order to cope with such requirements, heat dissipation performance per unit area of the heat spreader 1 can also be further enhanced.

Furthermore, in a case where the heat spreader according to the present invention is used, designing a compact and high-output semiconductor device is enabled. As described above, in order to join a semiconductor device (chip) or the like on the heat spreader, nickel plating, gold plating, a resist, or the like is applied to desired portions. In addition, in consideration of a difference between thermal expansions of an insulating substrate or the like and the heat spreader, a bow or the like may be previously imparted to the heat spreader. It is also possible to combine these heretofore known technologies and the heat spreader according to the present invention.

### EXAMPLES

### Example 1

A silicon carbide powder which is manufactured by Pacific Rundum Co., Ltd. and has a purity of 99.5% and a granularity of #320, an aluminum alloy powder which is manufactured by Toyo Aluminum K.K. and whose JIS alloy number is A1070, and an auxiliary agent were mixed, and the mixed powders whose volume contents of the silicon carbide particles were 20%, 40%, 60%, 80%, and 85%, were prepared as starting materials of the base material 11 of the heat spreader 1.

As starting materials of the surface layers 12 of the heat spreader 1, aluminum alloy plates whose JIS alloy number were A1050, and had plane dimensions of 120 mm×120 mm and thicknesses of 0.05 mm, 0.1 mm, 0.2 mm, 0.4 mm, 0.8 mm, and 1.2 mm were prepared.

Each of the mixed powders prepared as mentioned above was sandwiched by two aluminum alloy plates and each compact was formed by applying a load of 700 tons thereto with a press so as to have a size of 120 mm×120 mm×3.1 mm, whereby compacts were prepared.

Each of these compacts was heated in a nitrogen atmosphere at a temperature of 650° C. for eight hours, and thereafter, a load of approximately 1500 tons was further applied thereto with a press at a high temperature. Each of the obtained compacts was heated at a temperature of 630° C., and thereafter, was subjected to rolling processing so as to obtain a thickness of 3 mm as a plate-like member. As described above, as shown in FIG. 1, plate-like members, each of which included the base material 11 and the surface layers 12 constituting the heat spreader 1, were prepared.

After the rolling processing, test samples of the plate-like members were subjected to physical cleaning by a nylon brush and chemical cleaning by a sodium hydroxide aqueous solution and a nitric acid aqueous solution.

By using a stud welder with model No. NSW CD9, manufactured by NIPPON STUD WELDING Co., Ltd., and an XY stage in combination, the columnar members 13 were joined to a central portion of one of surfaces of each of the test samples of the plate-like members. Specifically, as the columnar members 13, pins made of an aluminum alloy, whose JIS alloy number was A1050, each of which had a diameter of 3 mm×a length of 10 mm were used and the pins were arranged in a plane region of 60 mm×60 mm in a square-shaped manner at spacings of 6 mm, thereby joining the 121 pins thereto through the stud welding. As conditions of the stud welding, a voltage was 50V, a welding pressure was 50N, and an initial gap was 2.0 mm. As described above, the test samples of the heat spreader 1 were prepared.

On the other hand, as shown in FIG. 4, the insulating substrate 4 which included the aluminum layers 3 formed on both surfaces thereof, was made of aluminum nitride, and had a plane region of 58 mm×58 mm was prepared. After masking was applied to the surface of the surface layer 12 of the heat spreader 1, onto which the columnar members 13 were joined, in order to avoid being nickel-plated, a surface opposite thereto was nickel-plated. After the masking was removed, the one surface of the insulating substrate 4, on which the nickel-plated aluminum layer 3 was formed, was joined with the soldering layer 2 interposed therebetween. On the other of the surfaces of the insulating substrate 4, on which the aluminum layer 3 was formed, an IGBT as the semiconductor device 5 for driving a three-phase alternate-current motor 300 with an output of 90 W was joined with the soldering layer 2 interposed therebetween.

Thereafter, in a test apparatus of the heat dissipation structure for a semiconductor device as shown in FIG. 4, the heat spreader 1 was arranged so as to allow the heat spreader 1 to be directly water-cooled and a load test was conducted. As a coolant, pure water was used and a flow rate was 5 liters per minute. As loads, low, middle, and high resistances were imparted to the motor 300, an accelerated operation, a low-speed operation, and a decelerated operation were repeated, respectively, and at this time, operating states of the IGBT were judged.

In addition, as shown in FIG. 2 and FIG. 3, in the joining layer 14 in which the columnar members 13 were joined, a proportion of an area of the joining interface 15 being present in the surface layer 12 was calculated by being converted in terms of a plane projected to the other surface of the plate-like member, by employing the method described above in the embodiments.

As a result, material compositions of the test samples (volume content percentages of silicon carbide (SiC) particles contained in the base material 11, thicknesses of each of the surface layers 12, with or without the columnar members 13 (pins)), preparation possible or impossible, the above-mentioned area proportions, properties thereof (heat conductivities and linear expansion coefficients), and results of the load test (IGBT endurance test) are shown in Table 1.

In Table 1, results of comparison examples, in each of which the surface layers 12 were not formed on both surfaces of the base material 11 in a configuration of the heat spreader, and results of a conventional example, in which the columnar members 13 were not joined, are also shown together.

As the heat conductivities, values measured by a laser flash method (TC-7000 manufactured by ULVAC-RIKO Inc.) at a temperature of 23° C. are shown. As the linear expansion coefficients, inclinations measured by DTM5000 manufactured by Max Science Co. at temperatures of 30° C. through 120° C. are shown.

As the results of the load test, ◯ shows a normal operation, Δ shows a recoverable thermal runaway, and x shows a breakage.

TABLE 1

| | | Material Composition | | | | | Properties | | | | |
|---|---|---|---|---|---|---|---|---|---|---|---|
| | | | Surface | | | | | Linear | | | |
| | | SiC | Layer | With/ | Preparation | Area | Heat | Expansion | IGB Endurance Test | | |
| | | Percentage | Thickness | Without | Possible/ | Proportion | Conductivity | Coefficient | Low | Middle | High |
| | No. | [%] | [mm] | Pins | Impossible | [%] | [W/m · K] | [×10⁻⁶/K] | Load | Load | Load |
| Example | 1 | 20 | 0.1 | With | Possible | 51 | 204 | 16 | ◯ | ◯ | X |
| of the | 2 | 40 | 0.1 | With | Possible | 52 | 205 | 14.1 | ◯ | ◯ | Δ |
| Present | 3 | 40 | 0.2 | With | Possible | 83 | 201 | 14.3 | ◯ | ◯ | Δ |
| Invention | 4 | 40 | 0.4 | With | Possible | 100 | 205 | 15 | ◯ | ◯ | Δ |
| | 5 | 60 | 0.1 | With | Possible | 50 | 212 | 9.7 | ◯ | ◯ | ◯ |
| | 6 | 60 | 0.2 | With | Possible | 80 | 214 | 10.6 | ◯ | ◯ | ◯ |
| | 7 | 60 | 0.4 | With | Possible | 100 | 209 | 14.7 | ◯ | ◯ | Δ |
| | 8 | 80 | 0.1 | With | Possible | 50 | 199 | 6 | ◯ | ◯ | ◯ |
| | 9 | 80 | 0.2 | With | Possible | 82 | 198 | 8 | ◯ | ◯ | ◯ |
| | 10 | 80 | 0.4 | With | Possible | 100 | 195 | 9.4 | ◯ | ◯ | ◯ |
| | 11 | 80 | 0.8 | With | Possible | 100 | 200 | 12.7 | ◯ | ◯ | Δ |
| Conventional | 12 | 60 | 0 | Without | — | — | 210 | 9.5 | ◯ | Δ | X |
| Example | | | | | | | | | | | |
| Comparison | 13 | 20 | 0 | With | With Type. 3 | 0 | 210 | 15.2 | — | — | — |
| Example | 14 | 20 | 0.05 | With | With Type. 3 | 28 | 205 | 15.4 | — | — | — |
| | 15 | 20 | 0.2 | With | Possible | 82 | 203 | 17.7 | X | X | X |
| | 16 | 20 | 0.4 | With | Possible | 100 | 205 | 18 | X | X | X |
| | 17 | 20 | 0.8 | With | Possible | 100 | 201 | 19.5 | X | X | X |
| | 18 | 20 | 1.2 | With | Possible | 100 | 207 | 22 | X | X | X |
| | 19 | 40 | 0 | With | With Type. 3 | 0 | 204 | 13.8 | — | — | — |
| | 20 | 40 | 0.05 | With | With Type. 3 | 27 | 203 | 14 | — | — | — |
| | 21 | 40 | 0.8 | With | Possible | 100 | 203 | 17.1 | X | X | X |
| | 22 | 40 | 1.2 | With | Possible | 100 | 208 | 20.1 | X | X | X |
| | 23 | 60 | 0 | With | With Type. 3 | 0 | 210 | 9.5 | — | — | — |
| | 24 | 60 | 0.05 | With | With Type. 3 | 30 | 207 | 9.6 | — | — | — |
| | 25 | 60 | 0.8 | With | Possible | 100 | 206 | 17 | X | X | X |
| | 26 | 60 | 1.2 | With | Possible | 100 | 205 | 19.1 | X | X | X |
| | 27 | 80 | 0 | With | With Type. 3 | 0 | 198 | 5.8 | — | — | — |
| | 28 | 80 | 0.05 | With | With Type. 3 | 33 | 196 | 5.9 | — | — | — |
| | 29 | 80 | 1.2 | With | Possible | 100 | 201 | 18.4 | X | X | X |
| | 30 | 85 | 0 | With | Powder | — | — | — | — | — | — |
| | | | | | Forming | | | | | | |
| | | | | | Impossible | | | | | | |

In Table 1, in the column of “Preparation Possible/Impossible”, “Type 3” shows that one-time bending causes the columnar members 13 to be fractured, and this will be described later in Example 5.

It is seen from Table 1 that in order to join the columnar members 13, a plane layer 12 having a thickness greater than or equal to 0.1 mm is required. In addition, the test sample whose volume content percentage of the silicon carbide particles exceeds 85% could not be prepared.

It is seen that in order to obtain better properties than those of the heat spreader (No. 12) of the conventional example in which the pins are not joined, it is required to use a plate-like member whose linear expansion coefficient is less than or equal to 16×10⁻⁶/K. In addition, it is seen that in order to better properties, it is required to use a plate-like member whose linear expansion coefficient is less than or equal to 12×10⁻⁶/K.

It is seen that in order to obtain a plate-like member whose linear expansion coefficient is small, less than or equal to 16×10⁻⁶/K, it is required to reduce a thickness of the surface layer 12.

### Example 2

An influence of a heat conductivity of the plate-like member in the heat spreader 1 was investigated.

Upon preparing a test sample No. 6 by employing the same method as in Example 1, instead of the aluminum alloy powder, manufactured by Toyo Aluminum K.K., whose JIS alloy number is A1070, a powder was prepared as a starting material of the base material 11 such that magnesium of 6% by mass was added to an aluminum alloy powder whose alloy number is A1050 and the obtained powder was subjected to atomizing processing. By using powders obtained by blending, with varied blending ratios, this aluminum alloy powder with the magnesium added thereto and the aluminum alloy powder whose alloy number was A1050, test samples having different heat conductivities of the plate-like members, each of which was included in the heat spreader 1, were prepared.

Since as the starting material of the base material 11, the aluminum alloy powder with the magnesium added thereto was used, a heating temperature in a nitrogen atmosphere, a heating temperature upon press working at a high temperature, and a heating temperature upon rolling processing as mentioned in Example 1 were set to be up to 520° C. at minimum and adjusted in accordance with a melting point of the aluminum alloy powder with the magnesium added thereto.

Properties of the test samples prepared as described above were evaluated by employing the same method as in Example 1. The results are shown in Table 2.

TABLE 2

| | | Material Composition | | | | Properties | | | | |
|---|---|---|---|---|---|---|---|---|---|---|
| | | | Surface | | | | Linear | IGBT Endurance | | |
| | | SiC | Layer | Mg | Area | Heat | Expansion | Test | | |
| | | Percentage | Thickness | Amount | Proportion | Conductivity | Coefficient | Low | Middle | High |
| | No. | [%] | [mm] | [mass %] | [%] | [W/m · K] | [×10⁻⁶/K] | Load | Load | Load |
| Example | 6 | 60 | 0.2 | 0 | 80 | 214 | 10.6 | ◯ | ◯ | ◯ |
| of the | 6a | 60 | 0.2 | 1 | 82 | 203 | 10.7 | ◯ | ◯ | ◯ |
| Present | 6c | 60 | 0.2 | 2 | 79 | 181 | 10.7 | ◯ | ◯ | ◯ |
| Invention | 6d | 60 | 0.2 | 4 | 80 | 153 | 10.7 | ◯ | ◯ | Δ |
| Comparison | 6e | 60 | 0.2 | 6 | 81 | 140 | 10.8 | ◯ | Δ | — |
| Example | | | | | | | | | | |

As seen from Table 2, when a heat conductivity of the plate-like member included in the heat spreader 1 was greater than or equal to 150 W/m·K, excellent properties were exhibited, as compared with the conventional example (No. 12) in Example 1. Further, a heat conductivity of the plate-like member included in the heat spreader 1 was greater than or equal to 180 W/m·K, higher performance was exhibited.

Similarly, an influence of a heat conductivity of the surface layers 12 and an influence of a heat conductivity of the columnar members 13 were investigated. In any case, when a heat conductivity of the surface layers 12 or the columnar members 13 was smaller than 150 W/m·K, excellent properties could not be obtained, as compared with the conventional example in Example 1. In particular, when a heat conductivity of the columnar members 13 was smaller than 150 W/m·K, properties were inferior, as compared with the conventional example.

### Example 3

An influence of a thickness of the plate-like member in the heat spreader 1 was investigated.

Upon preparing test samples by employing the same method as in Example 1, with reference to the properties of the test sample No. 5, amounts of the mixed powder of the silicon carbide particles and the aluminum alloy powder, as the starting material of the base material 11, were adjusted, a thickness of each of the surface layers 12 of each thereof was set to be 0.1 mm and thicknesses of the whole plate-like member were set to be 0.4 mm, 0.5 mm, 1.0 mm, 2.0 mm, 4.0 mm, 6.0 mm, and 8.0 mm, whereby the plate-like members, each of which was included in the heat spreader 1, were prepared so as to have different thicknesses. Evaluation was conducted in the same manner as in Example 1.

The results are shown in Table 3.

TABLE 3

| | | Material Composition | | | | Properties | | | | |
|---|---|---|---|---|---|---|---|---|---|---|
| | | | Surface | | | | Linear | | | |
| | | SiC | Layer | Plate | Area | Heat | Expansion | IGBT Endurance Test | | |
| | | Percentage | Thickness | Thickness | Proportion | Conductivity | Coefficient | Low | Middle | High |
| | No. | [%] | [mm] | [mm] | [%] | [W/m · K] | [×10⁻⁶/K] | Load | Load | Load |
| Example | 5 | 60 | 0.1 | 3 | 50 | 212 | 9.7 | ◯ | ◯ | ◯ |
| of the | 5a | 80 | 0.1 | 0.5 | 51 | 220 | 11.8 | ◯ | Δ | Δ |
| Present | 5b | 75 | 0.1 | 1 | 52 | 218 | 10.1 | ◯ | ◯ | Δ |
| Invention | 5c | 65 | 0.1 | 2 | 51 | 211 | 10.5 | ◯ | ◯ | ◯ |
| | 5d | 60 | 0.1 | 4 | 50 | 212 | 9.6 | ◯ | ◯ | ◯ |
| | 5e | 60 | 0.1 | 6 | 53 | 214 | 9.5 | ◯ | ◯ | ◯ |
| | 5f | 80 | 0.1 | 0.4 | 52 | 210 | 12.6 | ◯ | Δ | Δ |
| | 5g | 60 | 0.1 | 8 | 51 | 220 | 9.7 | ◯ | Δ | Δ |

As seen from Table 3, when the test samples whose plate-like members had the thicknesses of 0.4 mm and 0.5 mm were subjected to the load test, waviness occurred when the middle load was exerted thereon and operational stability was lowered, as compared with that of the reference test sample. When the test samples whose plate-like members had the thicknesses of 0.5 mm and 1.0 mm were subjected to the load test, a case where operations were not stable due to deformations, which were considered to be waviness, when the high load was exerted thereon resulted. When the test samples whose plate-like members had the thicknesses in a range of 2.0 mm through 6.0 mm were subjected to the load test, any of the test samples allowed operations without any problems even when the high load was exerted thereon. However, the test sample whose plate-like member had the thickness of 8.0 mm could not allow a stable operation when the high load was exerted thereon.

### Example 4

An influence exerted by a shape of each of the pins as the columnar members 13 in the heat spreader 1 was investigated.

Upon preparing test samples by employing the same method as in Example 1, configurations except for lengths of the pins were made identical to that of the test sample No. 9, and the lengths of each of the pins, each of which had a diameter of 3 mm, were changed to be 1.5 mm, 3 mm, 6 mm, 9 mm, 12 mm, and 15 mm, whereby the test samples were prepared.

On the other hand, with respect to an influence of the diameter of each of the pins, upon preparing the test samples by employing the same method as in Example 1, configurations except for the lengths of the pins were made identical to that of the test sample No. 9, and while each space between the pins was maintained to be 3 mm which was a close space between the pins, each of which had the diameter of 3 mm, pins each having dimensions of a diameter 1.6 mm×a length 6.4 mm, a diameter 2 mm×a length 8 mm, a diameter 6 mm×a length 24 mm, a diameter 8 mm×length 32 mm, and a diameter 10 mm×a length 40 mm were formed and each arrangement thereof was made in a square-shaped manner, whereby the test samples were prepared.

By using a test apparatus of the heat dissipation structure for a semiconductor device as shown in FIG. 4 basically in the same manner as in Example 1, a load test was conducted. A thermocouple was installed on a semiconductor device (chip) 5, and a temperature of the semiconductor device 5 in a case where a middle load was exerted on a conventional example (test sample No. 12) and a temperature of the semiconductor device 5 in a case where the similar load was exerted on each of the test samples were compared, whereby an evaluation was conducted.

With respect to the length of each of the pins, when the length thereof was increased, a reduction in the temperature of the semiconductor device 5 was perceived. However, even by increasing the length of each of the pins so as to be larger than four times the diameter of each of the pins, there was no difference between the temperature of the conventional example and a temperature of the test sample which had a length of each of the pins, which was four times the diameter of each of the pins. A temperature intermediate between a temperature of the semiconductor device 5 of the conventional example having no pins joined thereto and the temperature of the semiconductor device 5 which had the length of each of the pins, which was four times the diameter of each of the pins, was obtained when a length of each of the pins corresponded to the diameter of each of the pins.

To sum up, with respect to the diameter of each of the pins, the temperature of the semiconductor device 5 was reduced in accordance with a decrease in the diameter of each of the pins so as to be lower than the temperature of the semiconductor device 5 of the conventional example having no pins joined thereto. A temperature of the semiconductor device 5 of the test sample which had the pins, each of which had the diameter of 10 mm, was not reduced so as to be lower than that of the conventional example. On the other hand, in the test sample to which the pins, each of which had the diameter of 1.6 mm, were joined, the pins were deformed by a water flow used for cooling after the load test was conducted. Such a deformation did not occur in the test sample to which the pins, each of which had the diameter of 2 mm, were joined.

### Example 5

In order to investigate a relationship between a joining strength of the pins as the columnar members 13 in the heat spreader 1 and a thickness of each of the surface layers 12 as well as a proportion of an area of the joining interface 15, test samples equivalent to the test samples No. 8 through No. 11 in Example 1 were prepared. In order to evaluate the joining strength of the pins, a plate-like member was fixed in a heat spreader 1 of each of the test samples and any 20 pins were pinched with pliers, whereby a bending test was conducted. At this time, a force imparted to the pliers was a torque of 2 kgf·m at maximum.

In the bending test, positions of the pins, at which fractures occurred, were classified. As a result, the positions of the pins, at which the fractures occurred, were classified into: the pins were completely fractured at shanks thereof (Type. 1); although endurance against bending at several times was exhibited, the pins were fractured so as to be eventually pulled out (Type. 2); and the pins were fractured upon bending at one time (Type. 3). In the same manner as in Example 1, as shown in FIG. 2 and FIG. 3, in the joining layer 14 in which the columnar members 13 were joined, a proportion of an area of the joining interface 15 which was present in the surface layer 12 was calculated by being converted in terms of a plane projected to the other surface of the plate-like member.

The results are shown in Table 4.

TABLE 4

| | | Material Composition | | | | | | |
|---|---|---|---|---|---|---|---|---|
| | | SiC | Surface Layer | Plate | | | | |
| | | Percentage | Thickness | Thickness | Fracture Manner | | | Area |
| | No. | [%] | [mm] | [mm] | Type. 1 | Type. 2 | Type. 3 | Proportion |
| Example | 8 | 80 | 0.1 | 3 | 3 pins | 17 pins | 0 pin | 50% |
| of the | 9 | 80 | 0.2 | 3 | 14 pins | 6 pins | 0 pin | 82% |
| Present | 9a | 80 | 0.3 | 3 | 18 pins | 2 pins | 0 pin | 95% |
| Invention | 9c | 80 | 0.35 | 3 | 19 pins | 1 pin | 0 pin | 99% |
| | 10 | 80 | 0.4 | 3 | 20 pins | 0 pin | 0 pin | 100% |
| | 11 | 80 | 0.8 | 3 | 20 pins | 0 pin | 0 pin | 100% |
| Reference | 28 | 80 | 0.05 | 3 | 0 pin | 0 pin | 20 pins | 28% |
| Example | 28a | 80 | 0.075 | 3 | 1 pin | 10 pins | 9 pins | 39% |
| | 29 | 80 | 1.2 | 3 | 20 pins | 0 pin | 0 pin | 100% |

It is seen from Table 4 that when a proportion of an area of the joining interface 15 which is present in the surface layer 12 exceeds 50%, the fracture manner (Type. 3) comes not to be perceived and at this time, the thickness of the surface layer 12 is 0.1 mm. In addition, it is seen therefrom that when a proportion of an area of the joining interface 15 which is present in the surface layer 12 reaches 100%, the fracture manner (Type. 1) comes to be perceived and at this time, the thickness of the surface layer 12 is 0.4 mm.

Since in applications of the heat spreader, it does not occur that the heat spreader is repeatedly subjected to a plastic deformation, a joining strength greater than or equal to that of a degree to which the fracture manner of (Type. 2) is perceived, that is, a joining strength of a degree to which the fracture manner of (Type. 3) is not perceived, is sufficient.

Upon preparing the test samples No. 8 and No. 9, a voltage as the condition of the stud welding was changed from 50V to 70V, the fracture manner of (Type. 3) was perceived in the test sample No. 8 and the fracture manner of (Type. 3) was not perceived in the test sample No. 9. A proportion of an area f the joining interface 15 which was present in the surface layer 12, which was obtained when the voltage as the condition of the stud welding was changed to 70V, was 29% in the test sample No. 8 and 52% in the test sample No. 9. In a case where the voltage as the condition of the stud welding was set to be less than or equal to 30V, sufficient molting energy required for joining could not be obtained. An appropriate applied pressure as a condition of the stud welding was in a range of 40N through 60N. When the applied pressure was lower as well as higher than the above-mentioned range, generation of an arc upon the stud welding was not stabilized. Similarly, an optimum initial gap as a condition of the stud welding was in a range of 0.5 mm through 5 mm. When the initial gap was low as well as high, the generation of the arc upon the stud welding was not stabilized. As described above, a joining state changes depending on the conditions of the stud welding. However, in order to maintain favorable joining, a proportion of an area of the joining interface 15, which is present in the surface layer 12, is required to be at least 50%.

### Example 6

Upon preparing the test samples by employing the same method as in Example 1, each constitution except for a matrix material of a composite material of which the base material 11 of the heat spreader 1 was formed, a material of the surface layers 12, and a material of the pins as the columnar members 13 were made identical to that of the test sample No. 2; respective aluminum alloys whose JIS alloy number was A1050 (an aluminum content greater than or equal to 99.50% by mass), whose JIS alloy number was A1070 (an aluminum content greater than or equal to 99.70% by mass), and whose JIS alloy number was A1100 (an aluminum content greater than or equal to 99.00% by mass) were used; and a combination of the matrix material of the base material 11, the material of the surface layers 12, and the material of the columnar members 13 was varied, whereby a corrosion state of the heat spreader 1 was investigated.

In the investigation, in consideration of a case where general tap water containing a slight amount of chlorine was used as a coolant in a heat dissipation structure for a semiconductor device, a 5% sodium chloride aqueous solution (temperature 40° C.) was selected as an accelerated corrosion liquid, and after 1000-hour immersion, the corrosion state was observed. A test region was supposed to be a plane region with 70 mm×70 mm including a plane region with 60 mm×60 mm of the plate-like member to which the pins were joined, and before the immersion, the other plane regions were subjected to anticorrosion treatment by applying enamel coating thereto.

According to a previously conducted investigation of contact immersion of the aluminum plate materials in the corrosion liquid, the aluminum alloys were less electrically noble in the order of the aluminum alloy with the alloy number A1100, the aluminum alloy with the alloy number A1050, and the aluminum alloy with the alloy number A1070.

A result of observing the corrosion state is shown in Table 5.

TABLE 5

| | Material Composition | | | Corrosion State | | |
|---|---|---|---|---|---|---|
| | Substrate | Surface | | Substrate | Surface | |
| No. | Matrix | Layer | Pin | Matrix | Layer | Pin |
| 2a | A1070 | A1070 | A1070 | Slight Corrosion | Corrosion with Through-Bores | Slight Corrosion |
| 2b | A1070 | A1070 | A1050 | — | Slight Corrosion | Moderate Corrosion |
| 2c | A1070 | A1070 | A1100 | — | Slight Corrosion | Moderate Corrosion |
| 2d | A1070 | A1050 | A1070 | Moderate Corrosion | Corrosion with Through-Bores | Slight Corrosion |
| 2 | A1070 | A1050 | A1050 | Moderate Corrosion | Corrosion with Through-Bores | Slight Corrosion |
| 2e | A1070 | A1050 | A1100 | — | Slight Corrosion | Moderate Corrosion |
| 2f | A1070 | A1100 | A1070 | Slight Corrosion | Corrosion with Through-Bores | Slight Corrosion |
| 2g | A1070 | A1100 | A1050 | Slight Corrosion | Corrosion with Through-Bores | Slight Corrosion |
| 2h | A1070 | A1100 | A1100 | Slight Corrosion | Corrosion with Through-Bores | Moderate Corrosion |
| 2i | A1050 | A1070 | A1070 | Moderate Corrosion | Corrosion with Through-Bores | Slight Corrosion |
| 2j | A1050 | A1070 | A1050 | — | Slight Corrosion | Moderate Corrosion |
| 2k | A1050 | A1070 | A1100 | — | Slight Corrosion | Moderate Corrosion |
| 2l | A1050 | A1050 | A1070 | Moderate Corrosion | Corrosion with Through-Bores | Slight Corrosion |
| 2m | A1050 | A1050 | A1050 | Slight Corrosion | Corrosion with Through-Bores | Slight Corrosion |
| 2n | A1050 | A1050 | A1100 | — | Slight Corrosion | Moderate Corrosion |
| 2o | A1050 | A1100 | A1070 | Moderate Corrosion | Corrosion with Through-Bores | Slight Corrosion |
| 2p | A1050 | A1100 | A1050 | Slight Corrosion | Corrosion with Through-Bores | Slight Corrosion |
| 2q | A1050 | A1100 | A1100 | Slight Corrosion | Corrosion with Through-Bores | Moderate Corrosion |
| 2r | A1100 | A1070 | A1070 | Great Corrosion | Corrosion with Through-Bores | Slight Corrosion |
| 2s | A1100 | A1070 | A1050 | — | Slight Corrosion | Moderate Corrosion |
| 2t | A1100 | A1070 | A1100 | — | Slight Corrosion | Moderate Corrosion |
| 2u | A1100 | A1050 | A1070 | Great Corrosion | Corrosion with Through-Bores | Slight Corrosion |
| 2v | A1100 | A1050 | A1050 | Great Corrosion | Corrosion with Through-Bores | Slight Corrosion |
| 2w | A1100 | A1050 | A1100 | — | Slight Corrosion | Moderate Corrosion |
| 2x | A1100 | A1100 | A1070 | Great Corrosion | Corrosion with Through-Bores | Slight Corrosion |
| 2y | A1100 | A1100 | A1050 | Great Corrosion | Corrosion with Through-Bores | Slight Corrosion |
| 2z | A1100 | A1100 | A1100 | Great Corrosion | Corrosion with Through-Bores | Moderate Corrosion |

Judging from Table 5, it can be said that by making the material of the pins less noble than the material of which the surface layers 12 are formed, early generation of corrosion with through-bores in the aluminum alloy of which the surface layers 12 are formed can be suppressed. Further, it can be seen that by making the matrix material of the base material 11 equivalent to or more noble than the material of which the surface layers 12 are formed, even in a case where the corrosion with the through-bores is generated, progress of the corrosion inside the base material 11 can be suppressed.

A result similar to the above-mentioned result was obtained even when the pins of the composite columnar members described in the embodiment were used.

### Example 7

An influence which was exerted on the corrosion by crystal grains of the aluminum or the aluminum alloy, of which the surface layers 12 or the columnar members 13 in the heat spreader 1 were formed, was investigated.

As a starting material of the surface layers 12, plates which were made of the aluminum alloy having average crystal grain sizes of 0.1 mm, 1 mm, 6 mm, 10 mm, and 18 mm and were prepared by changing rolling temperatures were used. Except for this, a heat spreader 1 equivalent to that of the test sample No. 2a in Example 6 was prepared and a corrosion test similar to that in Example 6 was conducted.

As a result, it was found that a density of a pitting corrosion portion per unit area was reduced in accordance with an increase in the crystal grain size, the pitting corrosion portion acting as a starting point of perforation corrosion. However, even by making the crystal grain size of the aluminum alloy of which the surface layers 12 were formed to be greater than or equal to 6 mm, few changes occurred. In a case where the crystal grain size of the aluminum alloy of which the surface layers 12 were formed was smaller than 6 mm, many portions where the pitting corrosion was caused coincided with a crystal grain boundary. On the other hand, in the test samples whose crystal grain sizes of the aluminum alloy of which the surface layers 12 were formed were greater than or equal to 6 mm, it was perceived that the pitting corrosion was caused in not only the crystal grain boundary but also the crystal grains.

Next, the test samples in which the plates of the aluminum alloy, as the starting material of the surface layers 12, having the above-mentioned average crystal grain sizes of 0.1 mm and 1 mm were used were further subjected to high temperature heat treatment (temperature 625° C.), whereby the crystal grain size of each of the aluminum alloys, of which the surface layers 12 were formed, was set to be 6 mm. In addition, the test samples, in each of which the plate of the aluminum alloy, as the starting material of the surface layers 12, having the above-mentioned crystal grain size of 6 mm was used, were subjected to ordinary softening treatment (heat treatment at a temperature of 345° C.) for removing a distortion. The test samples of the heat spreader 1, prepared as mentioned above, were subjected to the corrosion test in a manner similar to the above-described manner.

In each of the test samples, in which the plate of the aluminum alloy, as the starting material of the surface layers 12, having the above-mentioned crystal grain size of 6 mm was used and which was subjected to the softening treatment, because generation of the pitting corrosion in the crystal grains was more decreased, a density of the pitting corrosion was further reduced. On the other hand, in each of the test sample, in which the crystal grain size was grown to be 6 mm by the high temperature heat treatment, although a density of the pitting corrosion was reduced as compared with the test samples which had not been subjected to the high temperature heat treatment, pitting corrosion greater than those in the test samples which were subjected to the softening treatment was perceived in the surface layers 12. This difference was due to a difference between the crystal grain sizes of the aluminum alloys of which the pins were formed. In each of the test samples which were subjected to the high temperature heat treatment, the crystal grain size of the aluminum alloy of which the pins as the columnar members 13 were formed was greater than the crystal grain size of the aluminum alloy of which the surface layers 12 were formed, whereas in the test samples which were subjected to the softening treatment, the crystal grain size of the aluminum alloy of which the pins as the columnar members 13 were formed was smaller than the crystal grain size of the aluminum alloy of which the surface layers 12 were formed.

For verification, pins made of an aluminum alloy whose crystal grain size was greater than that of the aluminum alloy of which the surface layers 12 were made and pins made of an aluminum alloy whose crystal grain size was smaller than that of the aluminum alloy of which the surface layers 12 were made were respectively joined to the surface layers 12 of which the aluminum alloys having the crystal grain sizes of 1 mm and 6 mm were formed, and a corrosion test was conducted similarly in the above-described manner. The pins were prepared by cold plasticity processing and the crystal grain sizes thereof were approximately in a range of 0.02 mm through 0.1 mm. The pins whose crystal grain sizes were adjusted so as to be 0.5 mm, 3 mm, and 7 mm were used. Also in a result of this verification test, a tendency that the pitting corrosion of the surface layers 12 became large when the crystal grain size of the pins was greater than the crystal grain size of the surface layers 12 was perceived.

### Example 8

By using a silicon carbide powder manufactured by Pacific Rundum Co., Ltd. and having a purity of 99.5% and a granularity of #320, a skeleton made of silicon carbide particles having a voidage of 20% was formed, and thereafter, a casting aluminum alloy which had JIS alloy number AC3A and was heated at a temperature of 750° C. was permeated into the skeleton of the silicon carbide particles and was solidified under a pressure of 3 tons/cm² by using a molten metal forging apparatus, whereby one aluminum alloy cast having dimensions of 5 mm×130 mm×130 mm as a starting material of the base material 11 of the heat spreader 1 was prepared.

In addition, the silicon carbide powder manufactured by Pacific Rundum Co., Ltd. and having the purity of 99.5% and the granularity of #320 was added to a casting aluminum alloy, which had JIS alloy number AC4C and was melted at a temperature of 650° C., under a vacuum atmosphere such that a volume percent of the silicon carbide powder became 40%, and agitation compounding was performed. After the compounding, by returning the vacuum atmosphere to an atmosphere, another aluminum alloy cast having dimensions of 5 mm×130 mm×130 mm was prepared as a starting material of the base material 11 of the heat spreader 1.

By grinding surfaces of the two aluminum alloy casts prepared as described above, a thickness of each thereof was made to be 2.8 mm, and thereafter, plates of an aluminum alloy, as starting materials of the surface layers 12, having JIS alloy number A1050, each of which had a thickness of 0.1 mm, were diffusion-joined to both side surfaces of each of the two aluminum alloy casts (at a temperature of 550° C. for four hours under a pressure of 2 tons/cm²). By cutting the materials obtained as described above so as to have dimensions of 120 mm×120 mm, two plate-like members, each of which was made of the base material 11 and the surface layers 12 included in the heat spreader 1 as shown in FIG. 1, were prepared. By using these plate-like members, as similarly to in Example 1, cleaning processing of the plate-like members and joining of the columnar members 13 were performed. As described above, test samples of the heat spreader 1 were prepared.

By using the test samples of the heat spreader 1, as similarly to in Example 1, a load test (IGBT endurance test) was conducted in a test apparatus of the heat dissipation structure for a semiconductor device shown in FIG. 4. Although the former test sample of the heat spreader 1 was slightly inferior as compared with the test sample No. 8 in Example 1 and the latter test sample of the heat spreader 1 was slightly inferior as compared with the test sample No. 2 in Example 1, the former test sample exhibited properties substantially equivalent to those of the test sample No. 8 in Example 1 and the latter test sample exhibited properties substantially equivalent to those of the test sample No. 2 in Example 1.

However, residues of spatters after the stud welding in the test samples No. 8 and No. 2 in Example 1, in each of which the base material 11 prepared by employing the powder method was used, was less than those in the two test samples in Example 8, in each of which the base material 11 prepared by employing the melting method was used. In addition, when the bending test shown in Example 5 was conducted, a ratio of the fracture manner of (Type. 1) decreased and a ratio of the fracture manner (Type. 2) increased in the two test samples in Example 8, in each of which the base material 11 prepared by employing the melting method was used, resulting in a tendency that a joining strength was inferior, as compared with the test samples No. 8 and No. 2 in Example 1, in each of which the base material 11 prepared by employing the powder method was used. Regarding the above-described phenomena, it is presumed that since in the test samples No. 8 and No. 2 in Example 1, in each of which the base material 11 prepared by employing the powder method was used, because of presence of voids inside the base material 11, the aluminum or the aluminum alloy, of which the pins as the columnar members 13 to be joined were formed, melted upon the stud welding, and the melted surplus aluminum or aluminum alloy was absorbed into an inside of the base material 11 due to capillary permeation, also whereby the joining strength was enhanced.

### Example 9

Plates of aluminum, each of which had a thickness of 0.3 mm, having an aluminum purity of 99.9%, were diffusion-joined to surfaces of a plate (a plane region of 70 mm×70 mm) having a thickness of 0.7 mm and made of an commercially available aluminum nitride (MN) sintered body; a plate (a plane region 70 mm×70 mm) having a thickness of 0.3 mm and made of a commercially available silicon nitride (Si₃N₄) sintered body; a plate (plane region 70 mm×70 mm) having a thickness of 0.5 mm and made of a commercially available aluminum oxide (Al₂O₃); and a plate (plane region 70 mm×70 mm) having a thickness of 3 mm and made of a composite material manufactured by A.L.M.T. Corp. (Si—SiC: a composite material with silicon carbide particles dispersed in a silicon matrix, having a silicon carbide particle content of 70% by mass), respectively. As described above, plate-like members of the heat spreaders 1 made of the base materials 11 made of the above-mentioned respective kinds of materials and the surface layers 12 made of the aluminum plates were prepared.

By using these plate-like members, as similarly to in Example 1, cleaning processing of the plate-like members and joining of the columnar members 13 were performed. As described above, test samples of the heat spreader 1 were prepared. As shown in FIG. 5, on the surface layer 12 to which the columnar members 13 were not joined, an IGBT as a semiconductor device 5 whose specifications were the same as specifications of that used in Example 1 was joined, with a soldering layer 2 interposed therebetween. Thereafter, in a test apparatus of the heat dissipation structure for a semiconductor device as shown in FIG. 5, a load test (IGBT endurance test) was conducted in a manner similar to that in Example 1.

Properties of the test samples and a result of the load test are shown in Table 6.

TABLE 6

| | | | Properties | | | | | |
|---|---|---|---|---|---|---|---|---|
| | | | Heat | Linear Expansion | Area | IGBT Endurance Test | | |
| | | | Conductivity | Coefficient | Proportion | Low | Middle | High |
| | No. | | [W/m · K] | [×10⁻⁶/K] | [%] | Load | Load | Load |
| Example of | 31 | AlN | 170 | 4.6 | 100 | ◯ | ◯ | ◯ |
| the Present | 32 | Si₃N₄ | 160 | 3 | 96 | ◯ | ◯ | ◯ |
| Invention | 33 | Al₂O₃ | 121 | 7 | 93 | ◯ | ◯ | ◯ |
| | 34 | Si—SiC | 230 | 3 | 95 | ◯ | ◯ | ◯ |

It is seen from Table 6 that even when any of the heat spreaders 1 of the test samples was used, the semiconductor device operated without any problems even when the high load was exerted thereon.

The described embodiment and examples are to be considered in all respects only as illustrative and not restrictive. It is intended that the scope of the invention is, therefore, indicated by the appended claims rather than the foregoing description of the embodiment and examples and that all modifications and variations coming within the meaning and equivalency range of the appended claims are embraced within their scope.

### INDUSTRIAL APPLICABILITY

A heat spreader for a semiconductor device according to the present invention is used for a semiconductor device called a power device, such as an insulated gate bipolar transistor (IGBT), which is mounted in an automobile or the like in order to effectively dissipate heat generated from the semiconductor device.

1. A heat spreader (1) for a semiconductor device, comprising:
a plate-like member (11, 12) having one surface and the other surface opposite to the one surface;
a plurality of columnar members (13) joined onto at least the one surface of the plate-like member (11, 12); and
a joining layer (14) formed between the plate-like member (11, 12) and the columnar members (13), wherein
the plate-like member (11, 12) includes a base material (11) and surface layers (12) joined onto both side surfaces of the base material (11),
a linear expansion coefficient of the plate-like member (11, 12) is greater than or equal to 3×10⁻⁶/K and less than or equal to 16×10⁻⁶/K and a heat conductivity of the plate-like member (11, 12) is greater than or equal to 120 W/m·K,
the surface layers (12) are made of a material containing aluminum or an aluminum alloy,
the columnar members (13) are made of a material containing aluminum or an aluminum alloy,
a thickness of the plate-like member (11, 12) is greater than or equal to 0.5 mm and less than or equal to 6 mm and a thickness of each of the surface layers (12) is greater than or equal to 0.1 mm and less than or equal to 1 mm,
the joining layer (14) has a joining interface (15) on a boundary with the plate-like member (11, 12), and
a proportion of an area of the joining interface (15) being present in the surface layer (12) is greater than or equal to 50% and less than or equal to 100%, converted in terms of a plane projected to the one surface of the plate-like member.

2. The heat spreader (1) for a semiconductor device according to claim 1, wherein the material of the surface layers (12) is more electrically noble than the material of the columnar members (13).

3. The heat spreader (1) for a semiconductor device according to claim 2, wherein an aluminum content of the material containing the aluminum or the aluminum alloy and used for forming the surface layers (12) is higher than an aluminum content of the material containing the aluminum or the aluminum alloy and used for forming the columnar members (13).

4. The heat spreader (1) for a semiconductor device according to claim 2, wherein a crystal grain size of the aluminum or the aluminum alloy used for forming the surface layers (12) is greater than a crystal grain size of the aluminum or the aluminum alloy used for forming the columnar members (13).

5. The heat spreader (1) for a semiconductor device according to claim 1, wherein a starting material of the base material (11) is a powder material.

6. A member for a semiconductor device, comprising the heat spreader (1) for a semiconductor device according to claim 1.

7. A method for manufacturing the heat spreader (1) for a semiconductor device (1) according to claim 1, comprising the step of joining columnar members (13) onto at least one surface of a plate-like member (11, 12) by employing a stud welding method such that a proportion of an area of a joining interface (15) being present in a surface layer (12) is greater than or equal to 50% and less than or equal to 100%, converted in terms of the plane projected to the one surface of the plate-like member (11, 12).

8. The method for manufacturing the heat spreader (1) for a semiconductor device according to claim 7, wherein a crystal grain size of aluminum or an aluminum alloy used for forming the surface layers (12) is increased by heating at least the surface layers (12) before the step of joining the columnar members (13) onto at least the one surface of the plate-like member (11, 12) by employing the stud welding method.

9. The method for manufacturing the heat spreader (1) for a semiconductor device according to claim 7, wherein a crystal grain size of aluminum or an aluminum alloy used for forming the surface layers (12) is increased by heating at least the surface layers (12) after the step of joining the columnar members (13) onto at least the one surface of the plate-like member (11, 12) by employing the stud welding method.
